(19) United States
(12) Patent Application Publication
(10) Pub. No.: US 2007/0298254 A1
(43) Pub. Date: Dec. 27, 2007

(54) Molded flexible weatherstrips for windows and their method of manufacture

(76) Inventor: Jean-Loup Cretin, Marzy (FR)

Correspondence Address: CLARK & BRODY, 1090 VERMONT AVENUE, NW, SUITE 250, WASHINGTON, DC, 20005, US

(21) Appl. No.: 11/708,022

(22) Filed: Feb. 20, 2007

(30) Foreign Application Priority Data
Feb. 22, 2006 (FR) 06/01562

(51) Int. Cl. B32B 23/00

(52) U.S. Cl. 428/364; 156/245

(57) ABSTRACT

The invention relates to an injection-molded flexible molded weatherstrip, and to a method of manufacturing such weatherstrips. The invention applies to weatherstrips for mounting to bear resiliently against a window, such as a moving window in a motor vehicle. A weatherstrip (101) of the invention is essentially constituted by at least one elastomer composition and has on its surface an anti-friction coating (103) of a material that is adapted to present a small coefficient of friction relative to said window, and it is characterized in that said coating is formed integrally with said weatherstrip by multiple-injection molding said material and said or each composition or each of said compositions, which composition is based on at least one thermoplastic elastomer selected from the group consisting of thermoplastic vulcanisates (TPV) and styrene block copolymers (TPS).

The present invention relates to molded flexible weatherstrips and to a method of manufacturing such weatherstrips. The invention applies to weatherstrips for mounting to bear resiliently on a window, such as a moving window of a motor vehicle.

In known manner, weatherstrips that are to come into friction contact with a moving window include at least one flexible lip that performs a sealing function relative to the window, and an anti-friction coating (sometimes referred to as a “slippery” coating by the person skilled in the art) which is adapted to present a coefficient of friction that is small relative to the window. Such a weatherstrip is usually of the extruded type or else of the molded type.

An extruded weatherstrip can be obtained by co-extruding an elastomer composition that is to form in particular the flexible lip(s) together with an anti-friction composition that is to form the “slippery” coating, or else a varnish or an adhesive can be deposited in-line on the extrusion followed by flocking.

A molded weatherstrip is generally obtained by injection molding the elastomer composition that is to form the flexible lip(s), and then after said molding operation, varnishing or flocking is performed as a finishing operation. Mention can be made for example of document FR-A-2 825 945 describing a method of manufacturing a weatherstrip by injecting an elastomer composition into a mold onto a “slippery” film of the flocked type that has previously been placed in the mold.

A major drawback of that method of manufacturing a weatherstrip specifically by injection molding lies in its relatively high implementation cost, in particular because of the varnishing or flocking operations that finish off the molding operation.

An object of the present invention is to provide a flexible molded weatherstrip for mounting on a window, said weatherstrip being essentially constituted by at least one elastomer composition and having on its surface an anti-friction coating of a material adapted to present a small coefficient of friction relative to said window, which weatherstrip remedies the above-mentioned drawback and makes it possible in particular to omit the above-mentioned operation of varnishing or flocking.

To this end, a weatherstrip of the invention is such that said coating is formed integrally with said weatherstrip via multiple-injection molding of said material and of said or each composition, which composition is based on at least one thermoplastic elastomer selected from the group consisting of thermoplastic vulcanisates (TPV) and styrene block copolymers (TPS).

The term “multi-injection” is used in conventional manner in the present description to mean simultaneously injecting in distinct cavities materials that are plastic or that can be worked as though they were plastic. This can be referred to as dual-injection or triple-injection when two or three such materials are injected simultaneously into an injection mold. Reference can be made for example to document FR-A-2 725 152 for a description of such a multi-injection technique.

According to another characteristic of the invention, said weatherstrip does not have any reinforcement, being constituted solely by a flexible material formed by said elastomer composition, plus the coating.

Advantageously, the anti-friction coating presents thickness lying in the range 0.3 millimeters (mm) to 1.5 mm, inclusively, and it may be formed over all or part of the surface of at least one sealing lip forming part of said weatherstrip and intended to bear resiliently against said window.

In a first embodiment of the invention, said coating is made of a thermoplastic material that is compatible with said rubber composition and that is based on at least one thermoplastic polymer selected from the group consisting of polyethylenes, polypropylenes, polyamides, polymethyl methylacrylates, polycarbonates, and mixtures of said polymers.

Preferably, said coating is then based on at least one cross-linked polyethylene.

In a second embodiment of the invention, said coating is constituted by an elastomer material based on at least one thermoplastic vulcanisate (TPV) comprising a cross-linked elastomer, such as an ethylene/propylene/diene terpolymer (EPDM), and a polyolefin such as a polypropylene, the polyolefin being present in said vulcanisate at a content by weight lying in the range 10% to 90%, inclusively.

In a third embodiment of the invention, said coating is based on at least one polyurethane elastomer (PUR) or on at least one thermoplastic polyurethane elastomer (TPU).

It should be observed that these materials preferentially used for forming said anti-friction coating are particularly advantageous for imparting a low coefficient of friction to the weatherstrip relative to the window on which the weatherstrip is to be mounted, thus achieving improved ability to withstand wear.

In a first embodiment of the invention, said elastomer composition is based on a thermoplastic vulcanisate (TPV) comprising a mixture:

of a cross-linked elastomer synthesized by a metallocene catalyst and belonging to the group consisting of ethylene/propylene/diene terpolymers (EPDM), and polyoctenes; and

of a grafted polyolefin.

In a preferred version of this first embodiment, said thermoplastic elastomer is a mixture of cross-linked EPDM synthesized by a metallocene catalyst, and of a polypropylene.

In a second embodiment of the invention, said elastomer composition is based on a styrene block copolymer (TPS) of the styrene/ethylene/butylene/styrene (SEBS) block type.

According to another characteristic of the invention, each of said elastomer composition and/or the material of said coating comprises at least one compatibility agent (in addition to other ingredients commonly used in weatherstrips, such as fillers, plasticizers, etc.), such that said coating adheres to the remainder of said weatherstrip without an interface bonding layer.

Advantageously, the weatherstrip of the invention forms a wiper or a slider for a moving window of a motor vehicle.

A method of the invention for manufacturing the above-mentioned weatherstrips consists essentially in molding said elastomer composition and the material for performing said coating by dual-injection in a mold having a turntable or a rotary charger.

According to another characteristic of the invention, said method may consist essentially in dual-injection molding in said mold, said molding comprising in succession:

i) simultaneously injecting said elastomer composition and said coating material into two diametrically opposite mold cavities formed in said turntable or said rotary charger;

ii) turning said turntable or said charger through 180°; and

iii) simultaneously injecting said coating material and said elastomer composition into said cavities respectively containing said elastomer composition and said coating material so as to obtain, after cooling, two molded weatherstrips each incorporating said anti-friction coating.

Other characteristics, advantages, and details of the present invention appear on reading the following description of embodiments of the invention, given by way of non-limiting illustration, said description being made with reference to the accompanying drawings, in which:

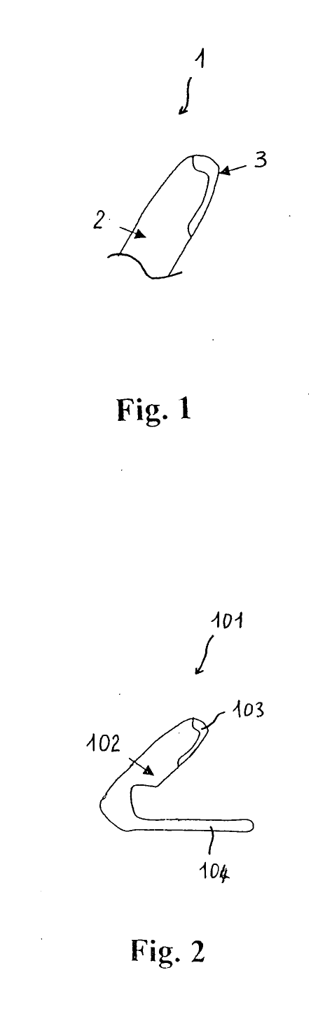

FIG. 1 is a fragmentary diagrammatic view in section of a sealing lip of a weatherstrip of the invention including an anti-friction coating obtained by dual-injection;

FIG. 2 is a diagrammatic section view of an example of a weatherstrip of the invention incorporating the coating of FIG. 1;

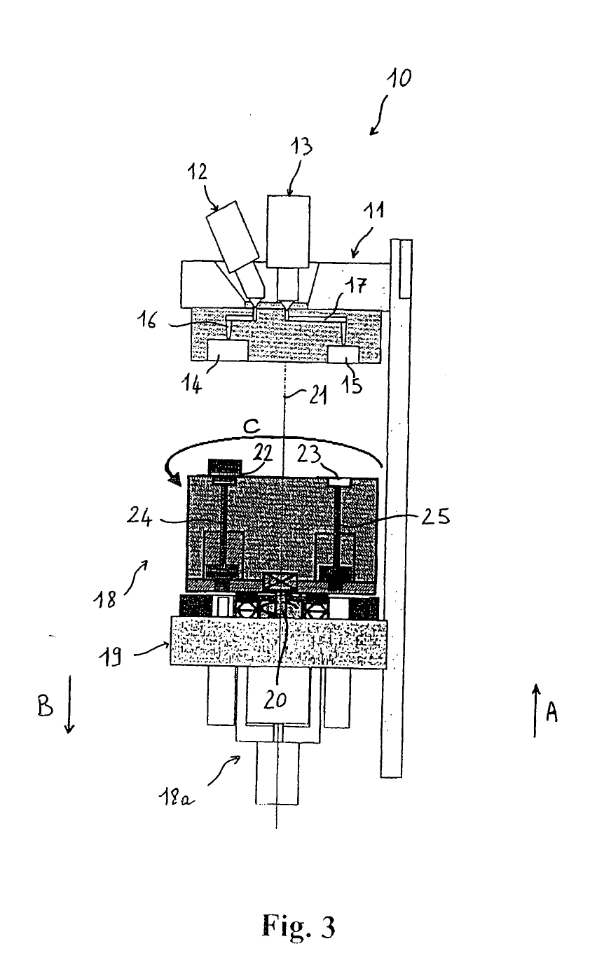

FIG. 3 is a section view of a dual-injection mold with a turntable, suitable for use in obtaining the part of FIGS. 1 or 2;

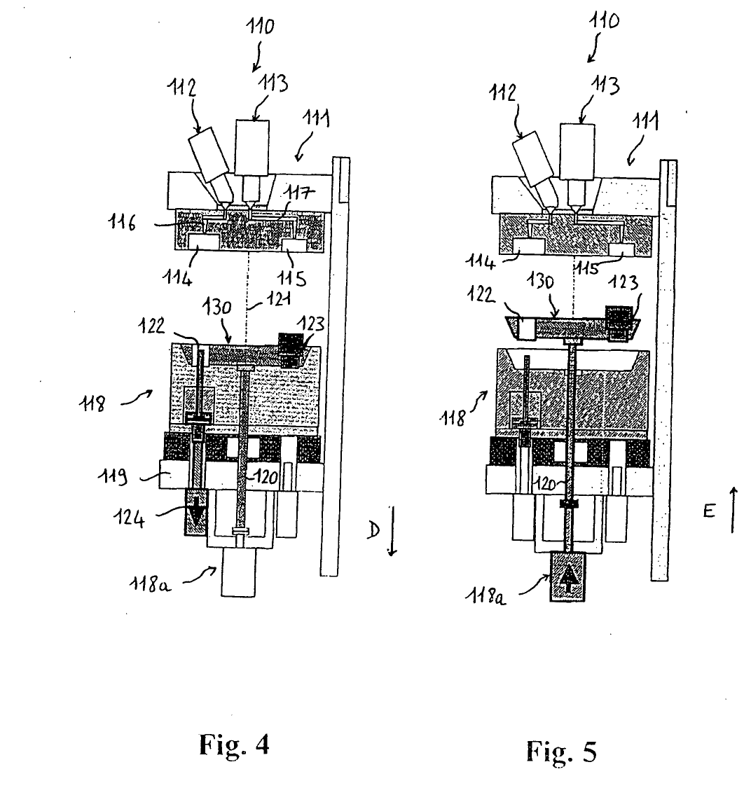

FIG. 4 is a section view of another dual-injection mold with a rotary charger also suitable for obtaining the molded part of FIGS. 1 or 2, the mold being shown in an open position relating to a first step of a molding cycle;

FIG. 5 is a section view of the FIG. 4 mold in an open position relating to a second step of the molding cycle;

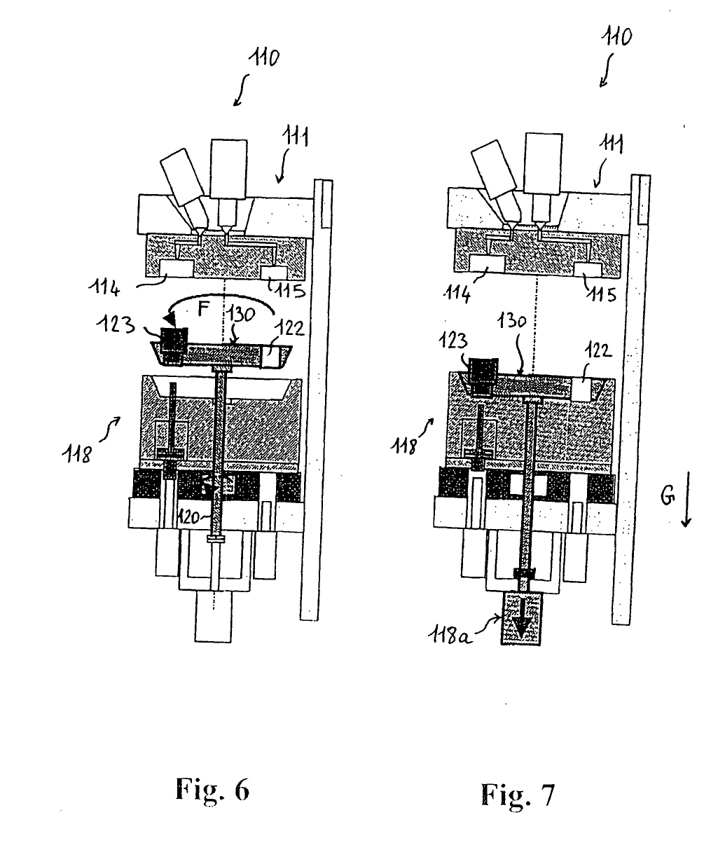

FIG. 6 is a section view of the FIG. 4 mold in an open position relating to a third step of the molding cycle;

FIG. 7 is a section view of the FIG. 4 mold in an open position relating to a fourth step of the molding cycle;

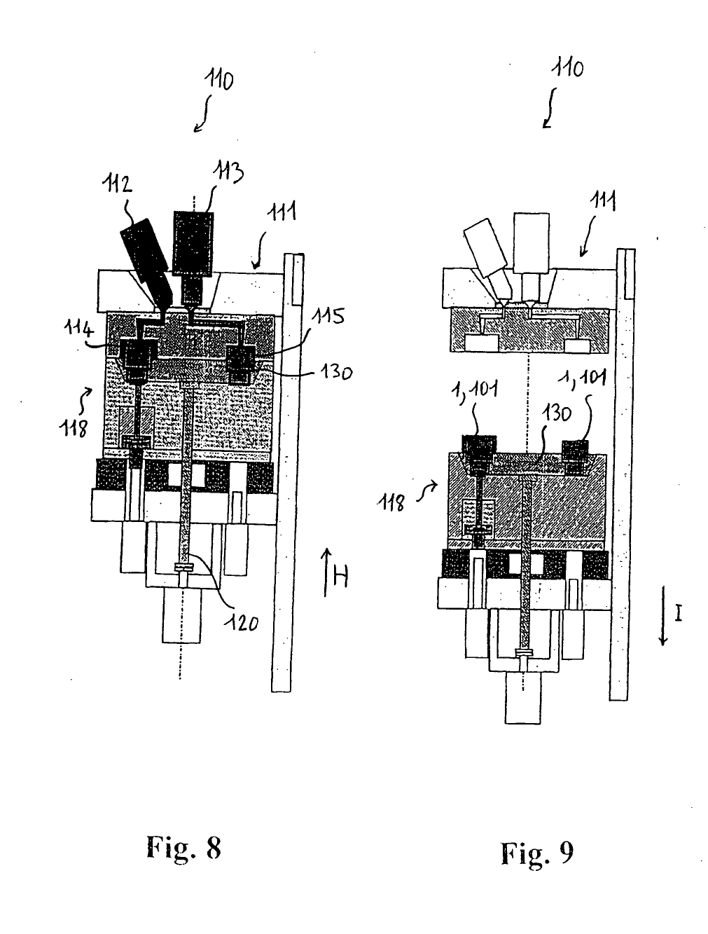

FIG. 8 is a section view of the FIG. 4 mold in an open position relating to a fifth and sixth steps of the molding cycle; and

FIG. 9 is a section view of the FIG. 4 mold in an open position relating to a seventh step of the molding cycle.

The weatherstrip 1 shown in part in FIG. 1 comprises a flexible lip 2 and an anti-friction coating 3 that covers the surface of the lip 2 and that is designed to present a small coefficient of friction relative to the glass constituting a window (not shown). The weatherstrip 1 is specifically obtained by dual-injection molding a flexible elastomer composition and a material that is suitable for forming the anti-friction coating 3, by implementing a molding method as described below.

The flexible weatherstrip 101 shown in FIG. 2 in this example presents a substantially V-shaped section, with one limb 102 forming a flexible lip covered in an anti-friction coating 103 for engaging a window, and with its other limb 104 forming an assembly support for assembly with a frame that receives the window. According to the invention, the weatherstrip 101 is obtained by dual-injection molding of the above-mentioned elastomer composition and of anti-friction material.

It should be observed that the weatherstrip obtained by dual-injection in accordance with the invention could present a shape other than that shown in FIG. 2, both for its anti-friction coating 3, 103 and for its support 104.

With reference to FIGS. 1 and 2, the flexible elastomer composition is based on a thermoplastic elastomer of the TPV type, such as a TPV known as “VEGAPRENE”, or else it is based on a styrene block thermoplastic elastomer of the SEBS type.

The material forming the coating 3, 103 is preferably based on a cross-linked polyethylene. It should be observed that other thermoplastic polymers can be used, such as polyethylenes, polypropylenes, polyamides, polymethyl methylacrylates, or polycarbonates, and even such as PUR, TPU, and even certain TPVs in which the content by weight of polyolefin can lie in the range 10% to 90%.

In a first embodiment of the invention, the mold 10, shown in an open position in FIG. 3, essentially comprises:

a stationary top table 11 having injector means 12 and 13 formed in inlets thereof for injecting two fluid compositions (there being two such compositions in this example because the mold is a dual-injection mold), and having two molding shapes 14 and 15 formed as outlets therefrom and communicating via respective channels 16 and 17 with the injector means 12 and 13; and

a bottom turntable 18 mounted on a stationary body 19 via a shaft 20, such that the turntable 18 can turn about the axis of symmetry 21 of the mold 10, the turntable 18 having two diagonally opposite counter-shapes 22 and 23 designed to co-operate with the corresponding shapes 14 and 15 of the stationary table 11 to form molding cavities.

More precisely, the turntable 18 is also provided in particular with means 24 and 25 for axially ejecting the molded weatherstrips 1, 101 contained respectively in said cavities, together with a cooling circuit (not shown) communicating therewith to cool the injected compositions.

The mold 10 is used as follows.

In a first step, it is closed by driving the bottom turntable 18 in axial translation in the direction of arrow A under the control of control means 18a forming part of the stationary body 19, so as to press the counter-shapes 22 and 23 under the shapes 14 and 15.

In a second step, the two compositions, the elastomer and the coating, are injected simultaneously via the injection means 12 and 13 into the resulting mold cavities 14-22 and 15-23.

In a third step, the mold 10 is opened by driving the bottom turntable 18 in axial translation in the direction of arrow B, using the control means 18a.

In a fourth step, the bottom turntable 18 is turned through an angle of 180° in the direction of arrow C, by driving the shaft 20 in that direction, and the first and second steps are then implemented again in order to obtain the two dual-injected weatherstrips 1, 101 by overmolding, each weatherstrip comprising the flexible portions 2, 102 and the coating portions 3, 103 bonded together.

Thereafter, the mold 10 is opened in order to eject the weatherstrips 1, 101 obtained in this way by using the means 24 and 25 to drive them in the direction of arrow A.

The mold 110 in a second embodiment of the invention is shown in the open position in FIG. 4 and comprises, essentially:

a stationary top table 111 having inlets formed by means 112 and 113 for injecting two fluid compositions and having an outlet provided with two shapes 114 and 115 communicating respectively via channels 116 and 117 with the injection means 112 and 113; and

a bottom table 118 mounted on a stationary body 119 and including a rotary charger 130 that is mounted to move in translation by control means 118a and that is mounted to move in rotation by a shaft 120 about the axis of symmetry 121 of the mold 110, the charger 130 having on its top face two diagonally opposite counter-shapes 122 and 123 designed to co-operate with the corresponding shapes 114 and 115 of the stationary table 11 to form mold cavities.

More precisely, the table 118 is also provided in particular with ejector means 124 for axially ejecting the molded weatherstrips 1, 101 contained respectively in said cavities, and also with a cooling circuit (not shown) communicating therewith to cool the injected compositions.

The mold 110 is used as follows, with reference to an operating cycle.

In a first step shown in FIG. 4, the mold is opened by driving the bottom table 118 in axial translation in the direction of arrow D, so as to separate the shapes 114 and 115 from the counter-shapes 122 and 123, the counter-shapes containing respectively said previously-injected compositions.

In a second step shown in FIG. 5, the charger 130 is driven axially in the direction of arrow E by the control means 118a so as to disengage it from the bottom table 118.

In a third step shown in FIG. 6, the charger 130 is turned through 180° (see arrow F) about the axis 121 by the shaft 120, so as to bring the counter-shapes 122 and 123 respectively into register with the shapes 114 and 115.

In a fourth step shown in FIG. 7, the charger 130 is returned axially in the direction of arrow G towards the control means 118a, so that it is again inserted in the table 118, and then it is locked thereto.

In a fifth step shown in FIG. 8, the mold 110 is closed by driving the bottom table 118 axially in the direction of arrow H so as to bring it against the stationary table 111, and then in a sixth step, said elastomer and coating compositions are injected simultaneously via the injector means 112 and 113 into the resulting mold cavities.

In a seventh step shown in FIG. 9, the mold 110 is opened by driving the bottom table 118 in axial translation in the direction of arrow I, and then the resulting dual-injected weatherstrips 1, 101 are ejected using the means 124.

It should be observed that in this second implementation of the dual-injection molding method of the invention, it is possible to minimize cycle time and to perform overmolding in three dimensions using two, three, or even four different materials.

1. A flexible molded weatherstrip (1, 101) for mounting on a window, said weatherstrip being essentially constituted by at least one elastomer composition and having on its surface an anti-friction coating (3, 103) of a material adapted to present a small coefficient of friction relative to said window, the weatherstrip being characterized in that said coating is formed integrally with said weatherstrip via multiple-injection molding of said material and of said or each composition, which composition is based on at least one thermoplastic elastomer selected from the group consisting of thermoplastic vulcanisates (TPV) and styrene block copolymers (TPS).

2. A weatherstrip (1, 101) according to claim 1, characterized in that it does not have reinforcement.

3. A weatherstrip (1, 101) according to claim 1, characterized in that said coating (3, 103) presents a thickness lying in the range 0.3 mm to 1.5 mm, inclusively.

4. A weatherstrip (1, 101) according to claim 1, characterized in that said coating (3, 103) is made on all or part of the surface of at least one sealing lip (2, 102) forming part of said weatherstrip and designed to bear resiliently against said window.

5. A weatherstrip (1, 101) according to claim 1, characterized in that said coating (3, 103) is made of a thermoplastic material that is compatible with said rubber composition and that is based on at least one thermoplastic polymer selected from the group consisting of polyethylenes, polypropylenes, polyamides, polymethyl methylacrylates, polycarbonates, and mixtures of said polymers.

6. A weatherstrip (1, 101) according to claim 5, characterized in that said coating (3, 103) is based on at least one cross-linked polyethylene.

7. A weatherstrip (1, 101) according to claim 1, characterized in that said coating (3, 103) is constituted by an elastomer material based on at least one thermoplastic vulcanisate (TPV) comprising a cross-linked elastomer, such as an ethylene/propylene/diene terpolymer (EPDM), and a polyolefin such as a polypropylene, the polyolefin being present in said vulvanisate at a content by weight lying in the range 10% to 90%, inclusively.

8. A weatherstrip (1, 101) according to any one of claim 1, characterized in that said coating (3, 103) is based on at least one polyurethane elastomer (PUR) or on at least one thermoplastic polyurethane elastomer (TPU).

9. A weatherstrip (1, 101) according to claim 1, characterized in that said elastomer composition is based on a thermoplastic vulcanisate (TPV) comprising a mixture:
of a cross-linked elastomer synthesized by a metallocene catalyst and belonging to the group consisting of ethylene/propylene/diene terpolymers (EPDM), and polyoctenes; and
of a grafted polyolefin, such as a polypropylene.

10. A weatherstrip (1, 101) according to claim 1, characterized in that said elastomer composition is based on a styrene block copolymer (TPS) of the styrene/ethylene/butylene/styrene (SEBS) block type.

11. A weatherstrip (1, 101) according to claim 1, characterized in that each of said elastomer composition and/or the material of said coating (3, 103) comprises at least one compatibility agent, such that said coating adheres to the remainder of said weatherstrip without an interface bonding layer.

12. A weatherstrip (1, 101) according to claim 1, characterized in that it forms a wiper or a slider for a moving window of a motor vehicle.

13. A method of manufacturing weatherstrips (1, 101) according to claim 1, characterized in that it consists essentially in molding said elastomer composition and the material for performing said coating (3, 103) by dual-injection in a mold (10, 1 10) having a turntable (18) or a rotary charger (130).

14. A method of manufacture according to claim 13, characterized in that said molding comprises in succession:
i) simultaneously injecting said elastomer composition and said coating material (3, 103) into two diametrically opposite mold cavities formed in said turntable (18) or said rotary charger (130);
ii) turning said turntable or said charger through 180°; and
iii) simultaneously injecting said coating material and said elastomer composition into said cavities respectively containing said elastomer composition and said coating material so as to obtain, after cooling, two molded weatherstrips (1, 101) each incorporating said anti-friction coating.
